(19) United States
(12) Patent Application Publication
(10) Pub. No.: US 2016/0288053 A1
(43) Pub. Date: Oct. 6, 2016

(54) DRAW SOLUTES INCLUDING PHOSPHONATE IONIC OLIGOMERS, FORWARD OSMOTIC WATER TREATING APPARATUS, AND METHODS USING THE SAME

(71) Applicant: SAMSUNG ELECTRONICS CO., LTD., Suwon-si, Gyeonggi-do (KR)

(72) Inventors: Chang Won SUH, Incheon-si (KR); Bo Kyung JUNG, Yongin-si (KR); Sung Soo HAN, Hwaseong-si (KR); Sang Cheon LEE, Seoul (KR)

(21) Appl. No.: 14/902,174

(22) PCT Filed: Jun. 30, 2014
(86) PCT No.: PCT/KR2014/005806

§ 371 Date: Dec. 30, 2015

(30) Foreign Application Priority Data
Jul. 1, 2013 (KR) 10-2013-0076626

(51) Int. Cl. B01D 61/00; C08F 8/44; C02F 1/44; C08F 8/40

(52) U.S. Cl. CPC B01D 61/005; C08F 8/40; C08F 8/44; C02F 1/445

(57) ABSTRACT

A draw solute including an ionic oligomer having a repeating unit that includes at least two phosphonate moieties and counter ions thereof, and a forward osmosis device and method for water treatment using the draw solute and an aqueous solvent, are disclosed.

### TECHNICAL FIELD

A draw solute including a phosphinate ionic oligomer, a forward osmotic water treating apparatus, and a forward osmotic water treating method using the same are disclosed.

### BACKGROUND ART

Osmosis (or forward osmosis) refers to a phenomenon in which an osmotic pressure causes water to move from a solution of a lower solute concentration to a solution of a higher solute concentration. In the reverse osmosis process, a pressure higher than the osmotic pressure is artificially applied so as to drive water in the opposite direction, producing fresh water.

The reverse osmosis process consumes a great deal of energy as it requires the application of a relatively high pressure. To increase energy efficiency, a forward osmosis process using the principle of osmotic pressure has been suggested. In the forward osmosis process, a draw solution of a higher concentration than a feed solution is used to move water molecules toward the draw solution and then the draw solute is separated from the draw solution to produce fresh water. The separated draw solute is often reused. In the forward osmosis process, separation and recovery of the draw solute consume most of the energy expenses.

It is desirable for the draw solute to be easily removed from the treated solution and then reused. Examples of the currently available draw solute include a thermally decomposable (or sublimatable) salt such as ammonium bicarbonate, a volatile solute such as sulfur dioxide, a soluble liquid or solid such as aliphatic alcohols and aluminum sulfate, sugars such as glucose and fructose, a polyvalent ionic salt such as potassium nitrate, magnesium chloride (MgCl₂), magnesium sulfate (MgSO₄), and the like. Examples of the newly suggested draw solute include magnetic nanoparticles having a hydrophilic peptide attached thereto, a polymer electrolyte such as a dendrimer, and the like.

However, the foregoing draw solutes cannot be used for the process for producing drinking water or water for general household use. For example, the ammonium bicarbonate should be heated to at least about 60° C. to be vaporized, thus requiring higher energy consumption. Also, since complete removal of ammonia is relatively difficult, the treated water smells of the ammonia. The polyvalent ionic salts may generate high osmotic pressure, but during the forward osmosis process, its reverse salt flux toward the feed solution is very high and thus the loss of the draw solute is severe. In addition, as the polyvalent ionic salt generally has a low molecular weight, a high energy recovery process using a tight nanofilter membrane is inevitable. Moreover, most of the aforementioned draw solutes may exhibit considerable toxicity so that they may not be used in the forward osmosis process for producing drinking water. For example, in the case of the magnetic nanoparticles, it is relatively difficult to redisperse magnetic particles that have been separated and agglomerated by application of a magnetic field, and it is also relatively difficult to completely remove the nanoparticles such that the toxicity of the nanoparticles should be considered. Heat-sensitive dendrimers or magnetic nanoparticles coated with a hydrophilic polymer or a hydrophilic low molecular substance have a size of several nanometers or tens of nanometers so that they require the use of a nanofilter membrane or ultrafilter membrane. In addition, the redispersion of the aggregated polymer is relatively difficult.

### DISCLOSURE

### Technical Objects

Various embodiments relate to a draw solute that may generate a relatively high osmotic pressure, that shows a relatively low level of reverse salt flux, and that may be recovered and recycled with relative ease.

Various embodiments relate to forward osmosis water treatment devices and methods using an osmosis draw solution including the draw solute and water.

### [Technical Solving Method]

One embodiment of the present invention provides a draw solute including an ionic oligomer having a repeating unit that includes at least two phosphonate moieties and counter ions thereof.

The repeating unit of the ionic oligomer may be represented by Chemical Formula 1:

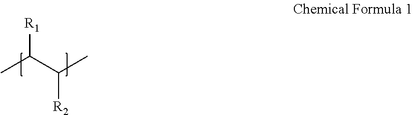

wherein R₁ and R₂ are the same or different, and are each independently hydrogen, a substituted or unsubstituted C1 to C10 alkyl group, or a group represented by Chemical Formula 2, provided that at least one of R₁ and R₂ is a group represented by Chemical Formula 2:

-ACX₁X₃R₃) Chemical Formula 2

wherein A is a direct bond, a substituted or unsubstituted C6 to C10 arylene group, a substituted or unsubstituted C1 to C10 alkylene group, a substituted or unsubstituted C1 to C10 oxyalkylene group, —CONR—(CR₂)ₙ— (wherein each R is the same or different and are each independently hydrogen or a C1 to C10 alkyl, and n is an integer of 1 to 20), X₁ and X₂ are the same or different, and are each independently PO₃HM or PO₃M₂ (wherein M is Na, Li, K, or Rb), and R₃ is a hydroxyl group.

The ionic oligomer may further include a repeating unit represented by Chemical Formula 3:

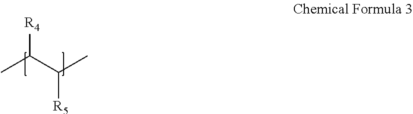

wherein R₄ and R₅ are the same or different, and are each independently hydrogen, a C1 to C10 alkyl, or a group represented by Chemical Formula 4, provided that at least one of R₄ and R₅ is a group represented by Chemical Formula 4:

-ACOOR₆) Chemical Formula 4

wherein A is a direct bond, a substituted or unsubstituted C6 to C20 arylene group, a substituted or unsubstituted C1 to C10 alkylene group, a substituted or unsubstituted C1 to C10 oxyalkylene group, or —CONR—(CRR)ₙ— (wherein each R is the same or different and are each independently hydrogen or a C1 to C10 alkyl), and R₆ is hydrogen or an alkali metal.

In the repeating unit represented by Chemical Formula 1 of the ionic oligomer, the amount of a bisphosphonate group may be greater than or equal to about 30 mol %.

The number average molecular weight of the ionic oligomer may be about 1000 g/mol to about 6000 g/mol.

The polydispersity of the ionic oligomer may be about 1.1 to about 1.8.

A draw solution including the draw solute at a concentration of 0.1 mol/L may generate an osmotic pressure of greater than or equal to about 30 atm as measured by a freezing point depression method.

The draw solute may have water flux of greater than or equal to about 5 LMH and a reverse solute flux of less than or equal to about 0.3 GMH at an osmotic pressure of about 50 atm.

The draw solute may have a self-diffusion coefficient ranging from 10⁻¹² to 10⁻¹⁰ m²/s.

In other embodiments of the present disclosure, a forward osmosis water treatment device may include: a feed solution including water and materials to be separated; an osmosis draw solution including an aqueous medium and an ionic oligomer that is dissolved in the aqueous medium and includes a repeating unit having at least two phosphonate moieties and counter ions thereof; a semipermeable membrane that is disposed to contact the feed solution on one side and the osmosis draw solution on the other side; a recovery system configured to remove at least a portion of the ionic oligomer from a treated solution including water that has moved from the feed solution to the osmosis draw solution through the semipermeable membrane by osmotic pressure; and a connector configured to reintroduce the ionic oligomer removed from the recovery system into the osmosis draw solution.

The repeating unit of the ionic oligomer may be represented by Chemical Formula 1:

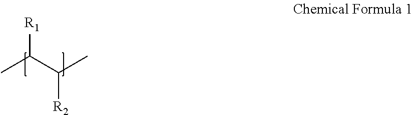

wherein R₁ and R₂ are the same or different, and are each independently hydrogen, a substituted or unsubstituted C1 to C10 alkyl group, or a group represented by Chemical Formula 2, provided that at least one of R₁ and R₂ is a group represented by Chemical Formula 2:

-ACX₁X₂R₃) Chemical Formula 2

wherein A is a direct bond, a substituted or unsubstituted C6 to C10 arylene group, a substituted or unsubstituted C1 to C10 alkylene group, a substituted or unsubstituted C1 to C10 oxyalkylene group, —CONR—(CR₂)ₙ— (wherein each R is the same or different and are each independently hydrogen or a C1 to C10 alkyl, and n is an integer of 1 to 20), X₁ and X₂ are the same or different, and are each independently PO₃HM or PO₃M₂ (wherein M is Na, Li, K, or Rb), and R₃ is a hydroxyl group.

The ionic oligomer may further include a repeating unit represented by Chemical Formula 3:

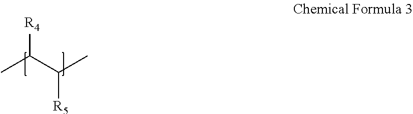

wherein R₄ and R₅ are the same or different, and are each independently hydrogen, a C1 to C10 alkyl, or a group represented by Chemical Formula 4, provided that at least one of R₄ and R₅ is the group represented by Chemical Formula 4:

-A(COOR₆) Chemical Formula 4

wherein A is a direct bond, a substituted or unsubstituted C6 to C20 arylene group, a substituted or unsubstituted C1 to C10 alkylene group, a substituted or unsubstituted C1 to C10 oxyalkylene group, or —CONR—(CRR)ₙ— (wherein each R is the same or different and are each independently hydrogen or a C1 to C10 alkyl), and R₆ is hydrogen or an alkali metal.

In the repeating unit represented by Chemical Formula 1 of the ionic oligomer, the amount of a bisphosphonate group may be greater than or equal to about 30 mol %.

The number average molecular weight of the ionic oligomer may be about 1000 g/mol to about 6000 g/mol.

The polydispersity of the ionic oligomer may be about 1.1 to about 1.8.

The recovery system may include one of a microfiltration membrane, an ultrafiltration membrane, a nanofiltration membrane, or a centrifugal separator.

In still another embodiment, a forward osmosis method for water treatment may include: contacting a feed solution, the feed solution including water and materials dissolved in the water, with an osmosis draw solution including an ionic oligomer with a semi-permeable membrane therebetween to obtain a treated solution including the water that moves from the feed solution to the osmotic draw solution through the semi-permeable membrane by osmotic pressure, the ionic oligomer being dissolved in the aqueous medium and including a repeating unit having at least two phosphonate moieties and counter ions thereof; and removing at least a portion of the ionic oligomer from the treated solution to obtain treated water.

The draw solution may generate osmotic pressure of greater than or equal to about 50 atm as measured by a freezing point depression method at a concentration of 0.1 mol/L.

The draw solution may have water flux of greater than or equal to about 5 LMH and reverse solute flux of less than or equal to about 0.3 GMH at an osmotic pressure of about 50 atm.

The forward osmosis method for water treatment may further include reintroducing the removed ionic oligomer into the draw solution.

### Advantageous Effect

The draw solute including the ionic oligomer may have a plurality of polyvalent ionic moieties and counter ions per repeating unit and thus may generate high osmotic pressure when being used in a draw solution. In addition, its reverse solute flux is low and its removal from the treated solution may be relatively easily achieved via filtration. Therefore, the forward water treatment apparatus and methods using the same may be operated at high energy efficiency and at a low cost.

### BRIEF DESCRIPTION OF THE DRAWINGS

FIG. 1 is a schematic view of a forward osmosis water treatment device according to exemplary embodiments.

FIG. 2 is a ³¹P-NMR analysis spectrum of the ionic oligomer synthesized in Example 1.

FIG. 3 includes a graph illustrating the changes of the osmotic pressure over the concentration (g/ml) for each of the solutions that include the ionic oligomer of Example 1 and the draw solute of Comparative Example 1, respectively.

FIG. 4 includes a graph illustrating the changes of the osmotic pressure over the concentration (g/ml) for each of the solutions that include the ionic oligomer of Example 1 and the draw solute of Comparative Examples 1 to 3, respectively.

FIG. 5 includes a graph illustrating results (water flux) of forward osmosis evaluation tests for the draw solution including the ionic oligomer of Example 1 and the draw solutions including the draw solute of Comparative Examples 1 to 3, respectively.

FIG. 6 includes a graph illustrating results (reverse solute flux) of forward osmosis evaluation tests for the draw solution including the ionic oligomer of Example 1 and the draw solutions including the draw solute of Comparative Examples 1 to 3, respectively.

### MODE FOR INVENTION

Exemplary embodiments will now be described more fully with reference to the accompanying drawings, in which some exemplary embodiments are shown. The exemplary embodiments may, however, be embodied in many different forms and should not be construed as being limited to the embodiments set forth herein; rather, these exemplary embodiments are provided so that this disclosure will be thorough and complete, and will fully convey the scope of the exemplary embodiments of inventive concepts to those of ordinary skill in the art. Therefore, in some exemplary embodiments, well-known process technologies may not be explained in detail in order to avoid unnecessarily obscuring of aspects of the exemplary embodiments. If not defined otherwise, all terms (including technical and scientific terms) in the specification may be defined as commonly understood by one skilled in the art.

The terms defined in a generally-used dictionary are not to be interpreted ideally or exaggeratedly unless clearly defined otherwise.

In addition, unless explicitly described to the contrary, the word “comprise” and variations such as “comprises” or “comprising” will be understood to imply the inclusion of stated elements but not the exclusion of any other elements.

Further, the singular includes the plural unless mentioned otherwise. In the drawings, the thickness of layers, regions, etc., are exaggerated for clarity. Like reference numerals designate like elements throughout the specification.

As used herein, the term “substitute” refers to replacing one or more of hydrogen in a given group with a hydroxyl group, a nitro group, a cyano group, an amino group, a carboxyl group, a linear or branched C₁ to C₃₀ alkyl group, a C₁ to C₁₀ alkyl silyl group, a C₃ to C₃₀ cycloalkyl group, a C₆ to C₃₀ aryl group, a C₂ to C₃₀ heteroaryl group, a C₁ to C₁₀ alkoxy group, a halogen, or a C₁ to C₁₀ fluoro alkyl group.

In one embodiment, the draw solute includes an ionic oligomer having a repeating unit that includes at least two phosphonate moieties and counter ions thereof. The repeating unit constitutes a main chain that may be formed by radical polymerization of a monomer having a carbon-carbon double bond (e.g., acrylic acid, styrene, or the like). The repeating unit may constitute a main chain that is formed by condensation polymerization (e.g., polyamic acid). The at least two phosphinate moieties may be in the form of bisphosphonate. The counter ions may be cations of an alkali metal such as lithium cations, sodium cations, potassium cations, rubidium cations, and the like. For example, the repeating unit of the ionic oligomer may be represented by Chemical Formula 1:

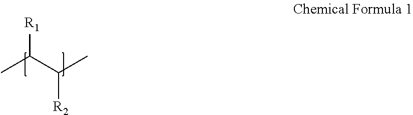

wherein R₁ and R₂ are the same or different, and are each independently hydrogen, a substituted or unsubstituted C1 to C10 alkyl group, or a group represented by Chemical Formula 2, provided that at least one of R₁ and R₂ is a group represented by Chemical Formula 2:

-ACX₁X₂R₃) Chemical Formula 2

wherein A is a direct bond, a substituted or unsubstituted C6 to C10 arylene group, a substituted or unsubstituted C1 to C10 alkylene group, a substituted or unsubstituted C1 to C10 oxyalkylene group, —CONR—(CR₂)ₙ— (wherein each R is the same or different and are each independently hydrogen or a C1 to C10 alkyl, and n is an integer of 1 to 20), and X₁ and X₂ are the same or different, and are each independently PO₃HM or PO₃M₂ (wherein M is Na, Li, K, or Rb), R₃ is a hydroxyl group.

The bisphosphonate moiety may have as many as 4 ionic groups and the moiety may have as many as 4 counter ions. Therefore, the ionic oligomer may generate a high level of osmotic pressure even at a low concentration when it is prepared as a draw solution. For example, at a predetermined concentration, the ionic oligomer may generate osmotic pressure two times higher than a conventional polymer draw solute.

The ionic oligomer may further include a repeating unit represented by Chemical Formula 3:

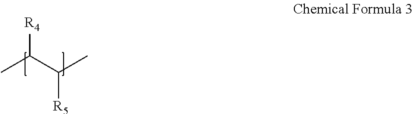

wherein R₄ and R₅ are the same or different, and are each independently hydrogen, a C1 to C10 alkyl, or a group represented by Chemical Formula 4, provided that at least one of R₄ and R₅ is the group represented by Chemical Formula 4:

-ACOOR₆) Chemical Formula 4

wherein A is a direct bond, a substituted or unsubstituted C6 to C20 arylene group, a substituted or unsubstituted C1 to C10 alkylene group, a substituted or unsubstituted C1 to C10 oxyalkylene group, or —CONR—(CRR)ₙ— (wherein each R is the same or different and are each independently hydrogen or a C1 to C10 alkyl), and R₆ is hydrogen or an alkali metal.

In a non-limiting example, the ionic oligomer may include a repeating unit as below.

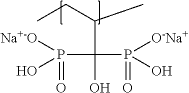

In another non-limiting example, the ionic oligomer may include a random co-oligomer having a repeating unit as below:

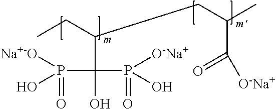

wherein m and m′ represent a polymerization degree, respectively.

In still another non-limiting example, the ionic oligomer may include the following repeating unit.

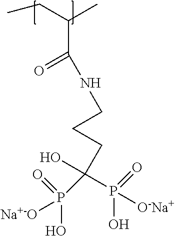

In the ionic oligomer, the amount of the repeating unit represented by Chemical Formula 1 (e.g., a repeating unit having at least two bisphosphonate group and counter ions thereof) may be greater than or equal to about 30 mol %, for example, greater than or equal to about 35 mol %, greater than or equal to about 40 mol %, greater than or equal to about 45 mol %, greater than or equal to about 50 mol %, greater than or equal to about 60 mol %, greater than or equal to about 70 mol %, greater than or equal to about 80 mol %, greater than or equal to about 90 mol %, or greater than or equal to about 99 mol %. In a non-limiting example, the number average molecular weight of the ionic oligomer may be about 1000 to about 6000 g/mol, for example, about 2000 to about 4000 g/mol. In a non-limiting example, in the ionic oligomer, the polymerization degree of the unit represented by Chemical Formula 1 (m) may be about 2 to about 20, and the polymerization degree of the unit represented by Chemical Formula 3 (m′) may be about 2 to about 20. When the ionic oligomer has a molecular weight or a polymerization degree within the aforementioned range, high osmotic pressure and low reverse solute flux may be accomplished. The polydispersity of the ionic oligomer (M_{w}/Mₙ) may be about 1.1 to about 1.8. When the polydispersity of the ionic oligomer is within the aforementioned range, the draw solute including the ionic oligomer may generate low reverse solute flux.

In case of a draw solution including the draw solute at a concentration of 0.1 mol/L, osmotic pressure generated by the draw solution may be greater than or equal to about 50 atm, for example, about greater than or equal to 55 bar, greater than or equal to about 61.4 bar, or greater than or equal to about 70 bar as measured by a freezing point depression method. As the draw solute includes an ionic oligomer having at least two polyanion groups per repeating unit and counter ions thereof, it may generate significantly enhanced osmotic pressure even at a low molar concentration (e.g., even when it is used in a small amount).

The draw solute may have water flux of greater than or equal to about 5 LMH and reverse solute flux of less than or equal to about 0.3 GMH at an osmotic pressure of about 50 atm or higher. For example, at an osmotic pressure of about 77.2 atm, the draw solute has water flux of 5 LMH or higher, e.g., greater than or equal to about 5.52 LMH, and the draw solute has reverse solute flux of 2.5 GMH or lower, for example, less than or equal to about 0.248 GMH. Conventional draw solutes including a polyvalent ionic compound (e.g., MgCl₂ and MgSO₄) may generate a relatively high level of osmotic pressure when they are dissolved in a large amount, but at the same time, they tend to show a relatively high level of reverse solute flux, which then leads to a relatively high loss and a relatively low recovery rate thereof, and also results in deterioration of the purity of the treated water. In particular, a “cake enhanced osmotic pressure” phenomenon may occur wherein the draw solute moved to the feed solution is confined in a fouling layer formed adjacent to the semipermeable membrane, causing an increase of osmotic pressure. Such a phenomenon may cause the osmotic pressure determined at the membrane surface contacting the feed solution to increase, resulting in a significant decrease in effective osmotic pressure and a lowered water flux. The draw solute including the aforementioned ionic oligomer may provide a high level of osmotic pressure while it may maintain the reverse flux of the solute at a low level (e.g., one third of the RSF of the conventional polyionic compound such as MgCl₂ and MgSO₄. Therefore, the draw solute may avoid a decrease in water flux that may occur as the water treatment time passes and the loss of the draw solute may be prevented, and thus the recovery rate of the draw solute may increase.

The draw solute may have a self-diffusion coefficient ranging from 10⁻¹² to 10⁻¹⁰ m²/S.

The ionic oligomer including a repeating unit represented by Chemical Formula 1 may be prepared by reacting an oligomer that has an appropriate molecular weight and includes a first reactive group (e.g., a carboxylic acid or its salt, or a succinimide group) in the presence of phosphorous acid (H₃PO₃) and PCl₃ in a suitable solvent. As an alternative, the ionic oligomer may be prepared by reacting the oligomer with a compound that has a bisphosphonate group and a second reactive group (e.g., an amine group, a thiol group, an alkoxide group, or a combination thereof).

Examples of the first reactive group may include a carboxylic acid, a salt of a carboxylic acid, a succinimide group, or a combination thereof. Examples of the oligomer having a suitable molecular weight may include, but are not limited to, polyacrylic acid and a copolymer thereof, poly(methacrylic acid) and a copolymer thereof, polyvinyl benzoic acid and a copolymer thereof, polymaleic acid anhydride and a copolymer thereof, poly N-acryloxysuccinimide and a copolymer thereof, and various oligomers or co-oligomers prepared by an addition polymerization reaction of a compound having the first reactive group (e.g., a carboxylic acid or a salt thereof, succinimide, and the like) and a carbon-carbon double bond. The oligomer (or co-oligomer) having a suitable molecular weight may be prepared by any known radical polymerization method or is commercially available. The oligomer may be prepared by a living radical polymerization method capable of precisely controlling its molecular weight (e.g., atom transfer radical polymerization: ATRP). Specific manners and conditions for the living radical polymerization are known in the art.

In non-limiting examples, the oligomer having a carboxylic acid or a salt thereof (as the first reactive group) may react in the presence of the phosphorous acid (H₃PO₃) and PCl₃ in a suitable solvent to produce the ionic oligomer having a repeating unit including at least two phosphonate moieties and counter ions thereof. Examples of the solvent may include, but are not limited to, an inert polar solvent such as chlorobenzene, methane sulfonic acid, sulfolane, and NMP. The amount of the reactants, a reaction temperature, and a reaction time may be selected appropriately.

Alternatively, the oligomer having a succinimide group as a first reactive group may react with a compound having the bisphosphonate group and a second reactive group (e.g., an amine group, a thiol group, an alkoxide group, or a combination thereof) capable of reacting with the first reactive group to produce the ionic oligomer having a repeating unit having at least two phosphonate moieties and counter ions thereof. Specific conditions (e.g., a reaction temperature, duration, a solvent, and the like) for such a reaction may be appropriately selected in light of the types of the first reactive group, the types of the oligomer, the types of the second reactive group, and the like.

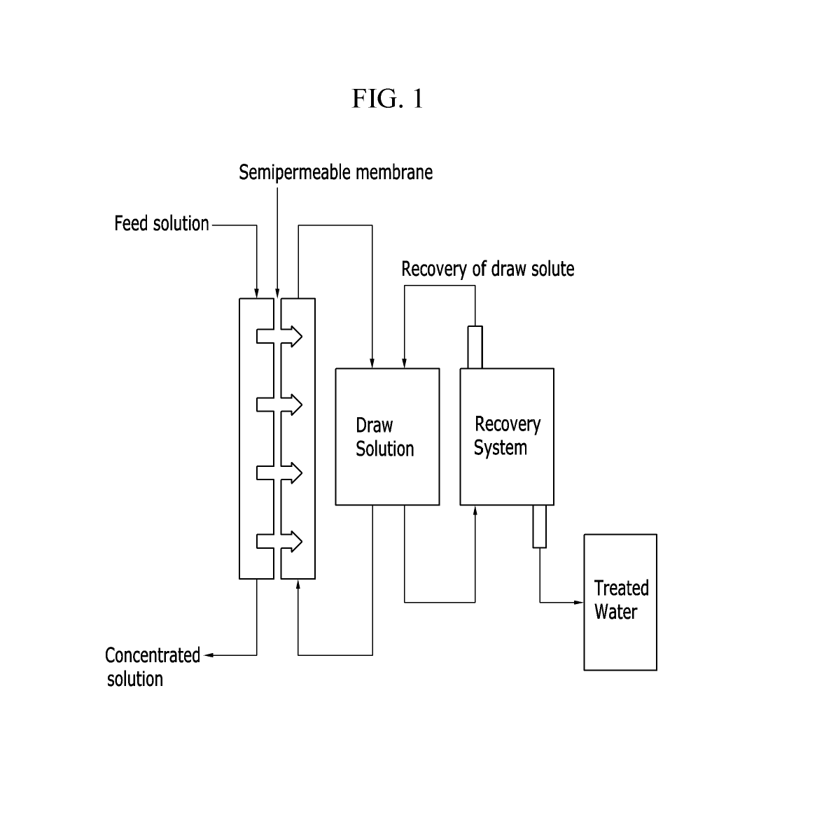

Another embodiment of the present invention provides a forward osmosis water treatment device using a draw solution including the ionic oligomer. The forward osmosis water treatment device may include: a feed solution including water and materials to be separated; a draw solution including an aqueous medium and an ionic oligomer that is dissolved in the aqueous medium and includes a repeating unit having at least two phosphonate moieties and counter ions thereof; a semipermeable membrane that is disposed to contact the feed solution on one side and the osmosis draw solution on the other side; a recovery system configured to remove at least a portion of the ionic oligomer from a treated solution including water that has moved from the feed solution to the osmosis draw solution through the semipermeable membrane by osmotic pressure; and a connector configured to reintroduce the ionic oligomer removed from the recovery system into the osmosis draw solution. FIG. 1 shows a schematic view of a forward osmosis water treatment device according to exemplary embodiments that may be operated by the forward osmosis water treatment method that will be explained below.

The semipermeable membrane is permeable to water and impermeable to the materials to be separated. The semipermeable membrane includes a porous layer and a dense layer, and the porous layer is in contact with the draw solution and the dense layer is in contact with the feed solution. The types of the feed solution are not particularly limited as long as they may be treated in the forward osmosis manner. The materials to be separated may be impurities or salts. Specific examples of the feed solution may include, but are not limited to, sea water, brackish water, ground water, and/or waste water. By way of a non-limiting example, the forward osmosis water treatment device may treat sea water to produce drinking water. In non-limiting examples, the concentration of the ionic oligomer in the draw solution is higher than that of the impurities in the feed solution.

Details of the ionic oligomer are the same as set forth above. The ionic oligomer has at least two phosphonate moieties and counter ions thereof per repeating unit, and thus may generate increased osmotic pressure even at a relatively low concentration in comparison with conventional draw solutes of an oligomer type. For example, the draw solute including poly(vinyl bisphosphonate) as the ionic oligomer may generate osmotic pressure of 0.86 bar to 62 bar at a concentration of 0.0035 M to 0.14 M under the conditions set forth below.

Semipermeable membrane: HTI flat sheet membrane

Feed solution: ultra-purified water (deionized water) (25° C.)

In this case, the draw solute may show optimum water flux of 0.12 to 0.45 LMH/bar, and reverse solute flux of less than or equal to about 0.5 GMH, for example, 0.25 to 0.37 GMH. As used herein, the term “LMH” refers to liter/m²h, and the term “GMH” refers to gram/m²h.

In addition, the ionic oligomer may pass through the porous layer of the semipermeable membrane and may easily reach the dense layer thereof, and this may control the internal concentration polarization at a relatively low level, leading to an increase of the effective osmotic pressure. In addition, the ionic oligomer reaching the dense layer may hardly diffuse in a reverse direction over the semipermeable membrane toward the feed solution. Therefore, the ionic oligomer may show a very low level of reverse solute flux in comparison with the conventional polyvalent salt draw solute, and thus it may perform the osmotic water treatment without showing a decrease in water flux during the long treating time.

In the recovery system, removal of the ionic oligomer may be carried out by filtration. The filtration means are not particularly limited, and may be a filtration membrane such as a microfiltration membrane, an ultrafiltration membrane, a nanofiltration membrane, or a loose reverse osmosis membrane, or a centrifugal separator. The removed oligomer may be re-introduced into a draw solution via the connector and may be used again as a draw solute. The forward osmosis water treatment device may further include an outlet for discharging treated water produced by removing the ionic oligomer from the treated solution in the recovery system. The types of the outlet are not particularly limited.

In still another embodiment, a forward osmosis method for water treatment may include: contacting a feed solution, the feed solution including water and materials dissolved in the water, with an osmosis draw solution including an ionic oligomer with a semi-permeable membrane therebetween to obtain a treated solution including the water that moves from the feed solution to the osmotic draw solution through the semi-permeable membrane by osmotic pressure, the ionic oligomer being dissolved in the aqueous medium and including a repeating unit having at least two phosphonate moieties and counter ions thereof; and removing at least a portion of the ionic oligomer from the treated solution to obtain treated water. When the feed solution and the draw solution are brought into contact with the semipermeable membrane disposed therebetween, water is driven to move from the feed solution through the semi-permeable membrane into the osmosis draw solution by osmotic pressure.

Details of the ionic oligomer, the semi-permeable membrane, the forward osmosis process, and the removal of the ionic oligomer are the same as set forth above.

Hereinafter, specific embodiments of the present invention are presented. However, the following examples and comparative examples are provided for the purpose of descriptions and the present invention is not limited thereto.

### EXAMPLES

### Preparation Example 1

### Synthesis of the Ionic Oligomer I

A poly(vinyl bisphosphonate) co-oligomer is synthesized in accordance with Reaction Scheme 1.

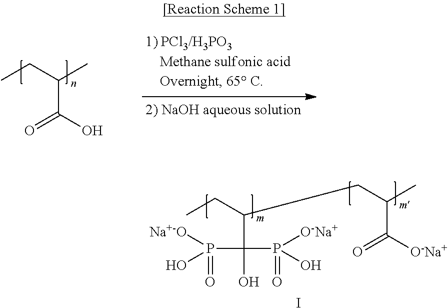

30 g of polyacrylic acid with a number average molecular weight of 1800 g/mol (from Sigma-Aldrich Co., Ltd.) is dissolved in a mixture of 68.4 g of phosphorous acid (H₃PO₃, 834 mmol) and 45 ml of methane sulfonic acid. The reaction mixture is stirred at 65° C. for 1 h. 58.1 ml of PCl₃ (834 mmol) is added thereto and the resulting mixture is stirred for 15 h. At room temperature, 450 ml of cold water (having a temperature of 5° C.) is used to quench the reaction. After quenching, the reaction product is further heated under reflux (at a temperature of 110° C.) for 5 h.

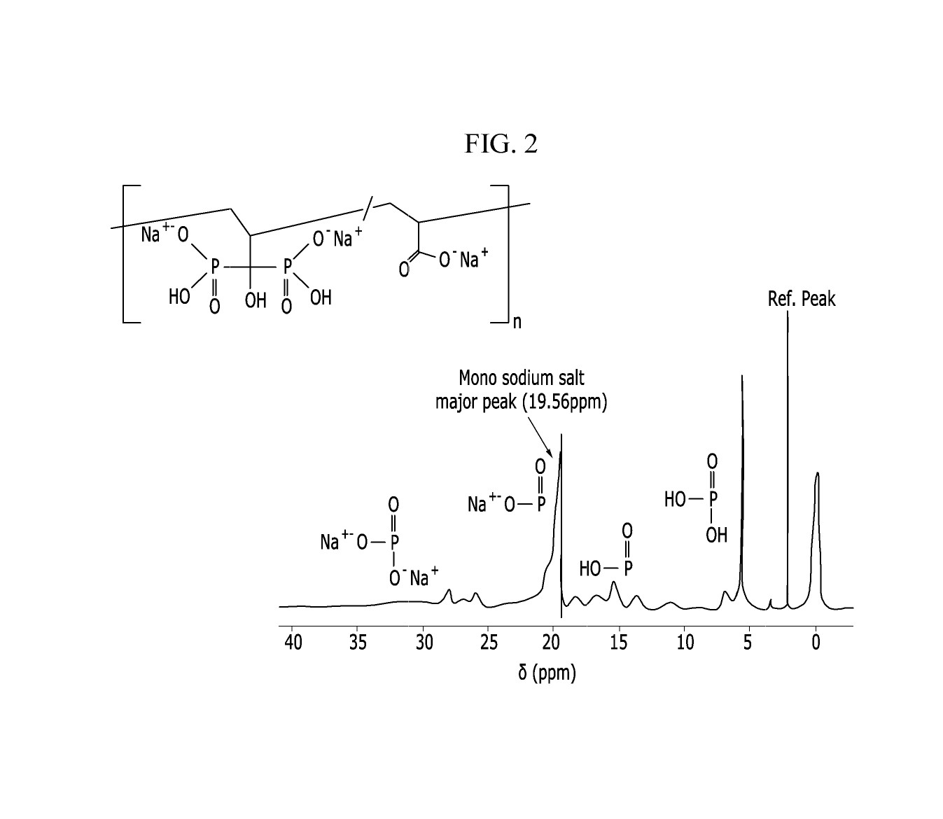

To the obtained reaction product is added 1N NaOH to control its pH to 10. The obtained reaction product is subject to dialysis with respect to distilled water to control its pH to 7, and then is freeze-dried to produce the ionic co-oligomer I, (vinyl bisphosphonate)-co-(acrylic acid sodium salt). For the ionic oligomer I, a P NMR analysis and an induced coupled plasma—atomic emission spectrum (ICP-AES) analysis are made. The ³¹P NMR spectrum of the ionic oligomer I is shown in FIG. 2. FIG. 2 and the results of the ICP-AES analysis confirm that in the ionic oligomer I, the amount of the repeating unit of vinyl bisphosphonate is about 50 mol %.

The GPC analysis made in the following conditions confirms that the synthesized ionic oligomer has a number average molecular weight of 3608 g/mol and a weight average molecular weight of 5397 g/mol, respectively, and its polydispersity is 1.5: Waters 515 pump, Waters 410 Differential Refractometer, TSKgel GMHxI (7.8×300 mm) column×2, flow rate: 1.0 mL/min, solvent: DMF+0.05 M LiBr)

### Preparation Example 2

### Synthesis of the Ionic Oligomer II

The ionic oligomer II is synthesized in accordance with Reaction Scheme 2.

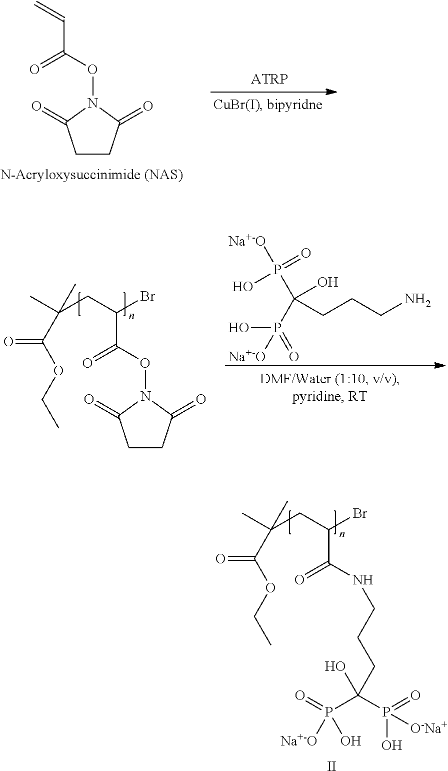

Atomic transfer radical polymerization is carried out using ethyl-α-bromoisobutyrate as an initiator, N-acryloxy succinimide as a monomer, CuBr(I) as a catalyst, bipyridine as a ligand, and DMF as a polymerization solvent at 80° C. for 24 h to obtain poly(N-acryloxy succinimide).

The poly(N-acryloxy succinimide) is dispersed in a mixture of DMF/water (1:10, pH 9.0) and is reacted with a 4-amino-1-hydroxy-1-phosphonopropyl)phosphonic acid salt at room temperature in the presence of pyridine to produce the ionic oligomer II.

The synthesized ionic oligomer has a number average molecular weight of 1396 g/mol, a weight average molecular weight of 1512 g/mol, and polydispersity of 1.08, respectively.

### Experimental 1

### Production of Draw Solution and Osmotic Pressure Analysis Thereof

The draw solutions are prepared using the ionic oligomer I synthesized in Preparation Example 1 (Example 1), polyacrylic acid (Comparative Example 1), MgCl₂ (Comparative Example 2), and MgSO₄ (Comparative Example 3) at various concentrations. An average value of the osmotic pressure of each draw solution is analyzed by using osmotic pressure measurement equipment (Gonetec, Osmomat 010) in accordance with the freezing point lowering method. Results are shown in Table 1.

TABLE 1

| Draw solution | Concentration | | Osmotic pressure (atm) | | | |
|---|---|---|---|---|---|---|
| (Draw solute) | (g/mL) | (mol/L) | 1 | 2 | 3 | Average |
| Comparative | 0.1 | 0.0316 | 2.62 | 2.66 | 2.66 | 2.65 |
| Example 1 | 0.2 | 0.0633 | 4.90 | 4.97 | 4.97 | 4.95 |
| (PAA) | 0.3 | 0.0949 | 8.80 | 8.75 | 8.84 | 8.80 |
| | 0.4 | 0.127 | 16.7 | 16.6 | 16.0 | 16.4 |
| | 0.5 | 0.158 | 32.1 | 33.2 | 33.0 | 32.8 |
| Comparative | 0.00476 | 0.05 | 2.98 | 2.98 | 2.98 | 2.98 |
| Example 2 | 0.00952 | 0.1 | 5.91 | 6.00 | 5.91 | 5.94 |
| (MgCl₂) | 0.0190 | 0.2 | 11.9 | 11.8 | 11.8 | 11.8 |
| | 0.0381 | 0.4 | 24.9 | 25.0 | 24.9 | 24.9 |
| | 0.0762 | 0.8 | 60.2 | 59.5 | 59.8 | 59.8 |
| Comparative | 0.0015 | 0.125 | 3.25 | 3.25 | 3.27 | 3.26 |
| Example 3 | 0.0301 | 0.25 | 5.91 | 6.11 | 6.09 | 6.04 |
| (MgSO₄) | 0.0602 | 0.5 | 11.6 | 11.5 | 11.6 | 11.6 |
| | 0.120 | 1 | 25.5 | 25.7 | 25.2 | 25.5 |
| Example 1 | 0.0125 | 0.00346 | 0.841 | 0.865 | 0.841 | 0.849 |
| (PVBP-1) | 0.025 | 0.00693 | 1.59 | 1.56 | 1.63 | 1.59 |
| | 0.05 | 0.0139 | 3.03 | 3.05 | 3.08 | 3.05 |
| | 0.1 | 0.0277 | 5.77 | 5.79 | 5.77 | 5.78 |
| | 0.2 | 0.0554 | 11.3 | 11.2 | 11.1 | 11.2 |
| | 0.4 | 0.111 | 33.4 | 33.5 | 33.3 | 33.4 |
| | 0.5 | 0.139 | 60.8 | 62.0 | — | 61.4 |

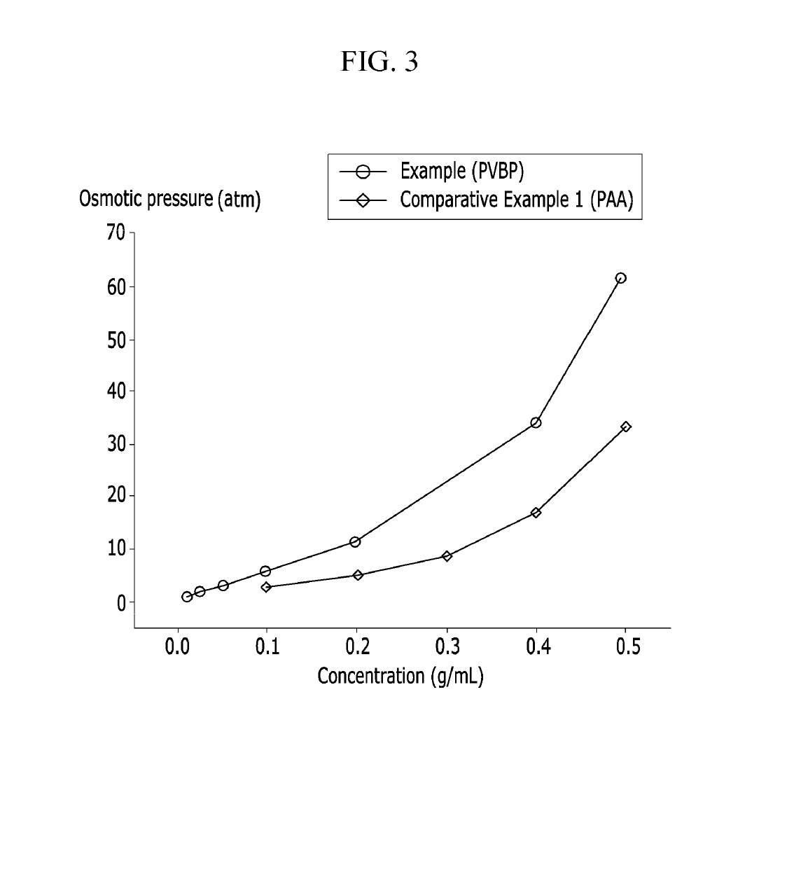

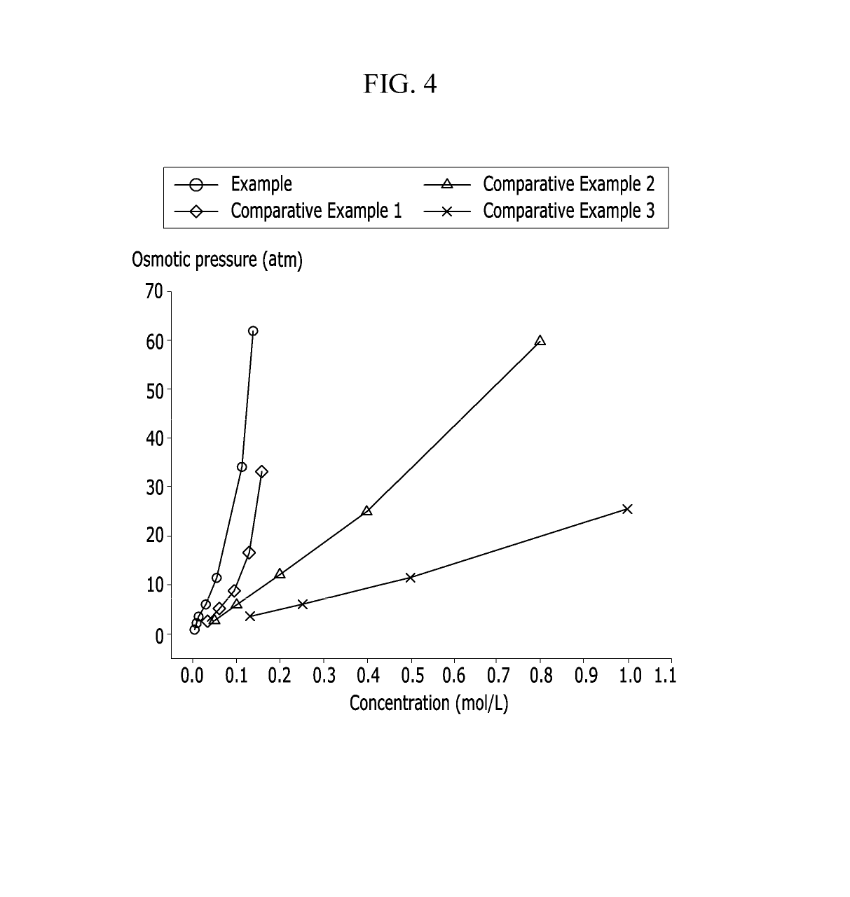

FIG. 3 shows a graph plotting the osmotic pressure over the change of the draw solution concentration (g/ml) for Example 1 and Comparative Example 1 corresponding to Table 1. FIG. 4 shows a graph of the results compiled in Table 1 based on the molar concentration. Referring to FIG. 3, the draw solution of Example 1 (PVBP-1) may generate an osmotic pressure of at least two times higher than that of the oligomer of Comparative Example 1 (PAA). Referring to FIG. 4, the osmotic pressure of the draw solute of Example 1 may be significantly higher than that of the single molecular polyvalent salt of the MgCl₂ (Comparative Example 2) and MgSO₄ (Comparative Example 3) at the same molar concentration. The aforementioned results confirm that the ionic oligomer of Example 1 may generate a high level of osmotic pressure even when it is used in a small amount in the forward osmotic water treatment. In addition, the recovery of the ionic oligomer of Example 1 may be carried out more easily because the amount of the ionic oligomer as used is small.

### Experimental Example 2

### Evaluation of Forward Osmotic Performance

The draw solutions are prepared by dissolving the ionic oligomer I synthesized in Preparation Example 1 (Example 1), polyacrylic acid (Comparative Example 1), MgCl₂ (Comparative Example 2), and MgSO₄ (Comparative Example 3), respectively. With respect to each of the draw solutions, an osmotic flow analysis is conducted in accordance with the following manner. The osmotic flow is evaluated with a homemade U-shaped semi-dynamic forward osmosis apparatus. To test performance of the draw solute, a semi-permeable commercialized FO membrane (cellulose trifluoroacetate) (Hydration Technology Innovation (HTI), USA) is placed in the middle of the apparatus. Each side is filled with distilled water as a feed solution and a draw solution with predetermined or given concentrations, respectively. The selective layer is faced toward the feed solutions and osmotic water flux from feed to draw solutions is calculated from the volumetric change of each solution during one h after 30 min. The reversed solute flux from draw to feed solution through the membrane is measured by conductivity (for Example 1 and Comparative Example 1) and total organic carbon (TOC) (for Comparative Examples 2 and 3).

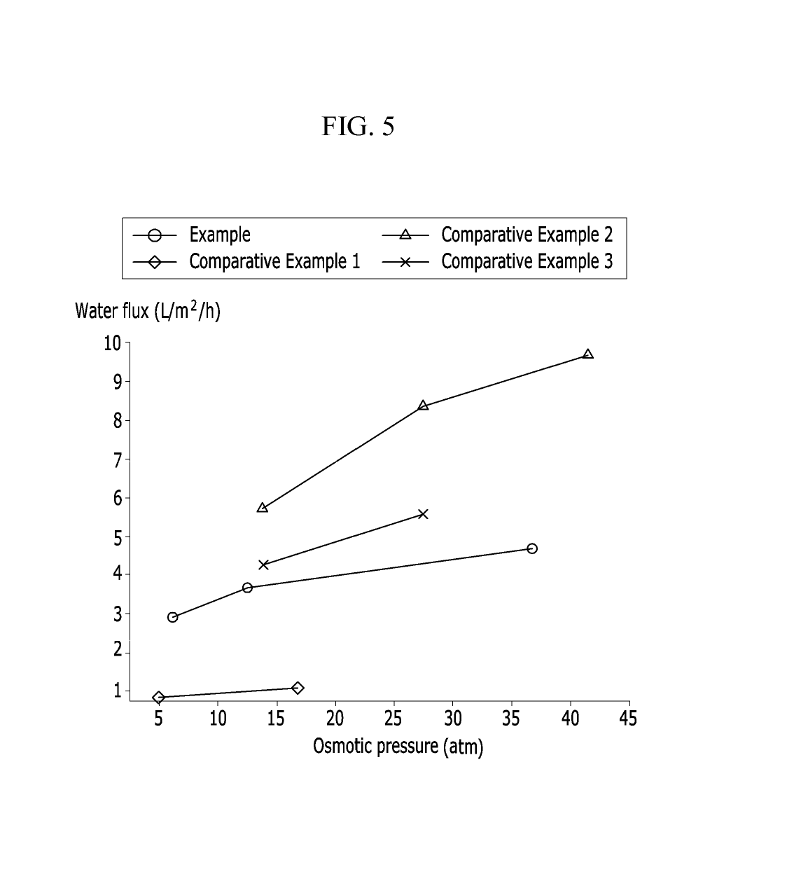

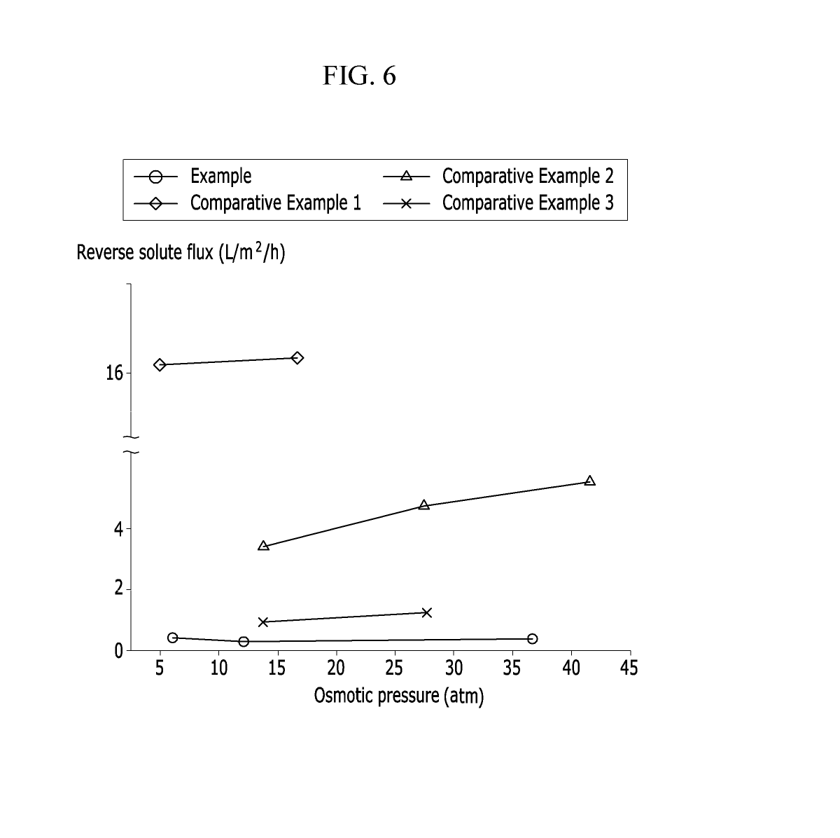

The results are shown in Table 2, FIG. 5, and FIG. 6. FIG. 5 shows graphs each plotting the water flux over the change of the osmotic pressure with respect to each of the draw solutions of Example 1 and Comparative Examples 1 to 3, respectively. FIG. 6 shows graphs each plotting the reverse solute flux over the change of the osmotic pressure with respect to each of the draw solutions of Example 1 and Comparative Examples 1 to 3, respectively. FIG. 5 and FIG. 6 do not include a data for the draw solution of which osmotic pressure is unavailable due to its concentration.

TABLE 2

| | | Osmotic | | Reverse |
|---|---|---|---|---|
| | Conc. | pressure | Water flux | solute flux |
| Draw solute | (g/mL) | (atm) | (L/m²/h) | (g/m²/h) |
| Comparative | 0.2 | 5.07 | 0.82 | 16.09 |
| Example 1 | 0.4 | 16.8 | 1.04 | 16.15 |
| (PAA) | 0.6 | — | 1.3 | 17.4 |
| Comparative | 0.02 | 13.8 | 5.67 | 3.4 |
| Example 2 | 0.034 | 27.6 | 8.39 | 4.8 |
| (MgCl₂) | 0.048 | 41.5 | 9.72 | 5.6 |
| Comparative | 0.074 | 13.8 | 4.25 | 0.9 |
| Example 3 | 0.14 | 27.6 | 5.54 | 1.2 |
| (MgSO₄) | | | | |
| Example 1 | 0.1 | 6.31 | 2.88 | 0.366 |
| (PVBP-1) | 0.2 | 12.4 | 3.64 | 0.245 |
| | 0.4 | 36.7 | 4.64 | 0.374 |
| | 0.6 | — | 5.52 | 0.248 |

The results of Table 2, FIG. 5, and FIG. 6 confirm the following. Comparative Example 2 and Comparative Example 3 include single molecular divalent salts as a draw solute, and these salts have a relatively high diffusion rate. Therefore, the draw solutions of Comparative Example 2 and Comparative Example 3 show higher water flux than those of the draw solutions of Example 1 and Comparative Example 1 both including a polymeric draw solute (see FIG. 6). However, the draw solutions of Comparative Example 2 and Comparative Example 3 have reverse solute flux of five to ten times higher than that of the draw solution of Example 1. It would be preferable for the draw solute to have high water flux. However, when the draw solute show high reverse solute flux together with high water flux, a severe loss of the draw solute may occur and this may become a serious problem. Therefore, a draw solute having a low level of reverse solute flux may be more desirable for the forward osmotic water treatment process. The draw solute of Comparative Example 1 has lower water flux than other draw solutes and a reverse solute flux much higher than other draw solutes, and thus it is undesirable to use it in the forward osmotic water treatment process.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A draw solute comprising an ionic oligomer having a repeating unit, the repeating unit including at least two phosphonate moieties and counter ions thereof.

2. The draw solute of claim 1, wherein the repeating unit of the ionic oligomer is represented by Chemical Formula 1: 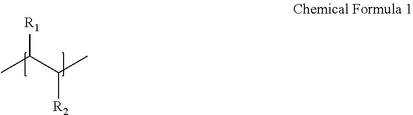
wherein each of R₁ and R₂ are the same or different, and are independently one of hydrogen, a substituted or unsubstituted C₁ to C₁₀ alkyl group, and a group represented by Chemical Formula 2, provided that at least one of R₁ and R₂ is a group represented by Chemical Formula 2:
-ACX₁X₂R₃) Chemical Formula 2
wherein A is one of a direct bond, a substituted or unsubstituted C₆ to C₁₀ arylene group, a substituted or unsubstituted C₁ to C₁₀ alkylene group, a substituted or unsubstituted C₁ to C₁₀ oxyalkylene group, and —CONR—(CR₂)ₙ— (wherein each R is the same or different and are independently one of hydrogen and a C₁ to C₁₀ alkyl, and n is an integer of 1 to 20),
each of X₁ and X₂ are the same or different, and are independently one of PO₃HM and PO₃M₂ (wherein M is one of Na, Li, K, and Rb), and
R₃ is a hydroxyl group.

3. The draw solute of claim 1, wherein the ionic oligomer further includes a repeating unit represented by Chemical Formula 3; 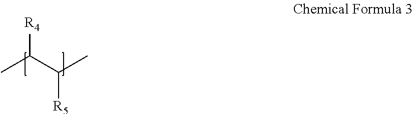
wherein each of R₄ and R₅ are the same or different, and are independently one of hydrogen, a C₁ to C₁₀ alkyl, and a group represented by Chemical Formula 4, provided that at least one of R₄ and R₅ is the group represented by Chemical Formula 4:
-ACOOR₆) Chemical Formula 4
wherein A is one of a direct bond, a substituted or unsubstituted C₆ to C₂₀ arylene group, a substituted or unsubstituted C₁ to C₁₀ alkylene group, a substituted or unsubstituted C₁ to C₁₀ oxyalkylene group, and CONR—(CRR)ₙ— (wherein each R is the same or different and are independently one of hydrogen and a C₁ to C₁₀ alkyl), and
R₆ is one of hydrogen and an alkali metal.

4. The draw solute of claim 2, wherein the amount of the repeating unit represented by Chemical Formula 1 is greater than or equal to about 30 mol % in the ionic oligomer.

5. The draw solute of claim 1, wherein a number average molecular weight of the ionic oligomer is about 1000 g/mol to about 6000 g/mol.

6. The draw solute of claim 1, wherein a polydispersity of the ionic oligomer is about 1.1 to about 1.8.

7. The draw solute of claim 1, wherein a draw solution including the draw solute at a concentration of 0.1 mol/L generates an osmotic pressure of greater than or equal to about 30 atm as measured by a freezing point depression method.

8. The draw solute of claim 1, wherein the draw solute has a water flux of greater than or equal to about 5 LMH and a reverse solute flux of less than or equal to about 0.3 GMH at an osmotic pressure of about 50 atm.

9. The draw solute of claim 1, wherein the draw solute has a self-diffusion coefficient ranging from 10⁻¹² to 10⁻¹⁰ m²/s.

10. A forward osmosis water treatment device comprising:
a feed solution including water and materials to be separated;
an osmosis draw solution including,
an aqueous medium, and
an ionic oligomer dissolved in the aqueous medium, the ionic oligomer includes a repeating unit having at least two phosphonate moieties and counter ions thereof;
a semipermeable membrane configured to contact the feed solution on a first side and the osmosis draw solution on a second side, the first side different from the second side;
a recovery system configured to remove at least a portion of the ionic oligomer from a treated solution including the water that moved from the feed solution to the osmosis draw solution through the semipermeable membrane by osmotic pressure; and
a connector configured to reintroduce the ionic oligomer removed from the recovery system into the osmosis draw solution.

11. The forward osmosis water treatment device of claim 10, wherein the repeating unit of the ionic oligomer is represented by Chemical Formula 1: 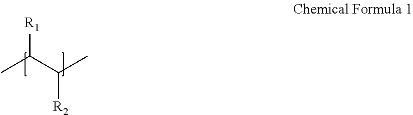
wherein each of R₁ and R₂ are the same or different, and are independently one of hydrogen, a substituted or unsubstituted C₁ to C₁₀ alkyl group, and a group represented by Chemical Formula 2, provided that at least one of R₁ and R₂ is a group represented by Chemical Formula 2:
-ACX₁X₂R₃) Chemical Formula 2
wherein A is one of a direct bond, a substituted or unsubstituted C₆ to C₁₀ arylene group, a substituted or unsubstituted C₁ to C₁₀ alkylene group, a substituted or unsubstituted C₁ to C₁₀ oxyalkylene group, and —CONR—(CR₂)ₙ— (wherein each R is the same or different and are independently one of hydrogen and a C₁ to C₁₀ alkyl, and n is an integer of 1 to 20),
each of X₁ and X₂ are the same or different, and are independently one of PO₃HM and PO₃M₂ (wherein M is one of Na, Li, K, and Rb), and
R₃ is a hydroxyl group.

12. The forward osmosis water treatment device of claim 10, wherein the ionic oligomer further comprises a repeating unit represented by Chemical Formula 3: 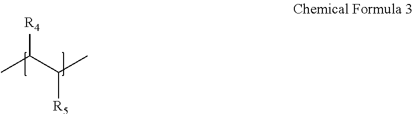
wherein each of R₄ and R₅ are the same or different, and are independently one of hydrogen, a C₁ to C₁₀ alkyl, and a group represented by Chemical Formula 4, provided that at least one of R₄ and R₅ is the group represented by Chemical Formula 4:
-ACOOR₆) Chemical Formula 4
wherein A is one of a direct bond, a substituted or unsubstituted C₆ to C₂₀ arylene group, a substituted or unsubstituted C₁ to C₁₀ alkylene group, a substituted or unsubstituted C₁ to C₁₀ oxyalkylene group, and —CONR—(CRR)ₙ— (wherein each R is the same or different and are independently one of hydrogen and a C₁ to C₁₀ alkyl), and
R₆ is one of hydrogen and an alkali metal.

13. The forward osmosis water treatment device of claim 10, wherein a polydispersity of the ionic oligomer is about 1.1 to about 1.8.

14. The forward osmosis water treatment device of claim 10, wherein the recovery system comprises one of a microfiltration membrane, an ultrafiltration membrane, a nanofiltration membrane, and a centrifugal separator.

15. A forward osmosis method for water treatment, the method comprising:
contacting a feed solution with a first side of a semi-permeable membrane, the feed solution including water and materials dissolved in the water, and an osmosis draw solution with a second side of the semi-permeable membrane different from the first side, the osmosis draw solution including an ionic oligomer, to obtain a treated solution including the water that moves from the feed solution to the osmotic draw solution through the semi-permeable membrane by osmotic pressure, the ionic oligomer being dissolved in an aqueous medium and including a repeating unit having at least two phosphonate moieties and counter ions thereof; and
removing at least a portion of the ionic oligomer from the treated solution to obtain treated water.

16. The forward osmosis method for water treatment of claim 15, wherein the repeating unit of the ionic oligomer is represented by Chemical Formula 1: 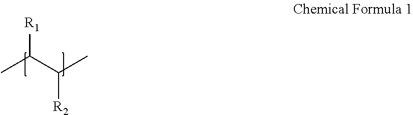
wherein each of R₁ and R₂ are the same or different, and are independently one of hydrogen, a substituted or unsubstituted C₁ to C₁₀ alkyl group, and a group represented by Chemical Formula 2, provided that at least one of R₁ and R₂ is a group represented by Chemical Formula 2:
-ACX₁X₂R₃) Chemical Formula 2
wherein A is one of a direct bond, a substituted or unsubstituted C₆ to C₁₀ arylene group, a substituted or unsubstituted C₁ to C₁₀ alkylene group, a substituted or unsubstituted C₁ to C₁₀ oxyalkylene group, and —CONR—(CR₂)ₙ— (wherein each R is the same or different and are independently one of hydrogen and a C₁ to C₁₀ alkyl, and n is an integer of 1 to 20),
each of X₁ and X₂ are the same or different, and are independently one of PO₃HM and PO₃M₂ (wherein M is one of Na, Li, K, and Rb), and
R₃ is a hydroxyl group.

17. The forward osmosis method for water treatment of claim 15, wherein the ionic oligomer further comprises a repeating unit represented by Chemical Formula 3; 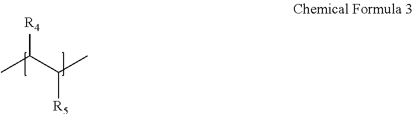
wherein each of R₄ and R₅ are the same or different, and are independently one of hydrogen, a C₁ to C₁₀ alkyl, and a group represented by Chemical Formula 4, provided that at least one of R₄ and R₅ is the group represented by Chemical Formula 4:
-ACOOR₆) Chemical Formula 4
wherein A is one of a direct bond, a substituted or unsubstituted C₆ to C₂₀ arylene group, a substituted or unsubstituted C₁ to C₁₀ alkylene group, a substituted or unsubstituted C₁ to C₁₀ oxyalkylene group, and —CONR—(CR₂)ₙ— (wherein each R is the same or different and are independently one of hydrogen and a C₁ to C₁₀ alkyl), and
R₆ is one of hydrogen and an alkali metal.

18. The forward osmosis method for water treatment of claim 16, wherein the amount of the repeating unit represented by Chemical Formula 1 is greater than or equal to about 30 mol % in the ionic oligomer.

19. The forward osmosis method for water treatment of claim 15, wherein the osmosis draw solution including the ionic oligomer at a concentration of 0.1 mol/L generates an osmotic pressure of greater than or equal to about 30 atm as measured by a freezing point depression method.

20. The forward osmosis method for water treatment of claim 15, wherein the draw solution has a water flux of greater than or equal to about 5 LMH and a reverse solute flux of less than or equal to about 0.3 GMH at an osmotic pressure of about 50 atm.
